(19) United States
(12) Patent Application Publication
(10) Pub. No.: US 2026/0005635 A1
(43) Pub. Date: Jan. 1, 2026

(54) CONTROLLING OF VARIABLE DC BUS VOLTAGE IN A MOTOR

(71) Applicants: STMICROELECTRONICS (BEIJING) R&D CO., LTD., Beijing (CN); STMICROELECTRONICS (SHENZHEN) R&D CO., LTD., Shenzhen (CN)

(72) Inventors: Xuen CHEN, Shenzhen (CN); Pengfei SUN, Qingdao (CN)

(73) Assignees: STMICROELECTRONICS (BEIJING) R&D CO., LTD., Beijing (CN); STMICROELECTRONICS (SHENZHEN) R&D CO., LTD., Shenzhen (CN)

(21) Appl. No.: 18/869,111

(22) PCT Filed: May 27, 2022
(86) PCT No.: PCT/CN2022/095646

§ 371 Date: Nov. 25, 2024

(51) Int. Cl. H02P 27/08; H02P 21/22

(52) U.S. Cl. CPC H02P 27/08; H02P 21/22; H02P 2207/05

(57) ABSTRACT

A method and apparatus for controlling a variable direct current (DC) bus of a motor drive are provided. A controller receives, over a first input, first and second component voltages of a first direct current (DC) voltage of the electric drive and determines an additional boost ratio of the electric drive based on the first and second component voltages. The controller determines a boost ratio of the electric drive as a sum of a minimum boost ratio and the additional boost ratio. The boost ratio is a ratio by which the electric drive steps up a second DC voltage into the first DC voltage. The controller generates a control signal for controlling the electric drive based on the boost ratio and outputs the control signal over an output.

### BACKGROUND

### Technical Field

This application is directed to controlling a voltage of a variable direct current (DC) bus in a motor and, in particular, controlling the voltage by automatically adjusting a factor by which a boost converter that steps up voltage supplied to the DC bus.

### Description of the Related Art

In many application, such as a compressor of an air conditioner, a motor DC bus is provided with an elevated voltage for high speed operation. However, retaining the DC bus at the elevated voltage during lower speed operation results in inefficient operation of the motor. In addition, retaining the elevated voltage leads to increasing the temperature of various components of the motor and, consequently, reducing the expected lifespan of the components.

### BRIEF SUMMARY

Techniques are provided herein for automatically changing a power factor used by a boost converter in an electric drive of a motor in order to mitigate losses, such as temperature losses. The boost converter outputs a DC voltage to a DC bus of the motor controller. The power factor of the boost converter is changed based on both an alternating current (AC) supply voltage that is provided to the electric drive and load conditions experienced by the motor.

A controller determines a peak voltage from the AC supply voltage. The controller boosts the peak voltage by a boost ratio that is greater than one. Boosting the peak voltage produces a reference voltage that is sought or desired for the DC bus. The controller determines the boost ratio as a sum of a minimum ratio and an additional ratio. The additional ratio is determined based on flux-weakening control. The controller may perform flux-weakening control to weaken a magnetic current of the motor. Flux-weakening uses stator current components to counter a fixed amplitude magnetic air gap flux generated by rotor magnets.

### BRIEF DESCRIPTION OF THE SEVERAL VIEWS OF THE DRAWINGS

FIG. 1 shows a system for controlling a motor.

FIG. 2 shows a functional diagram of a controller.

FIG. 3 shows a functional diagram of a DC bus voltage stage of the controller in accordance with an embodiment.

FIG. 4 shows temperature performance of the system.

### DETAILED DESCRIPTION

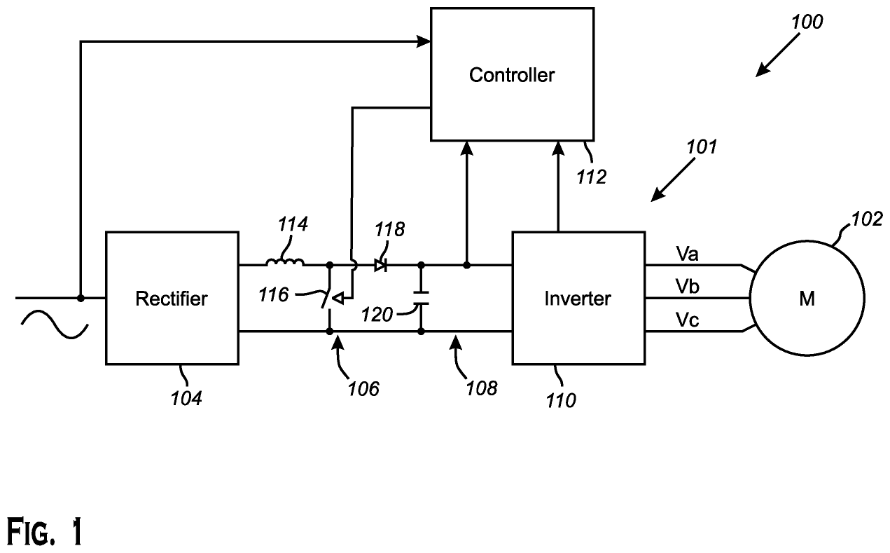

FIG. 1 shows a system 100 for controlling a motor 102. The system 100 includes an electric drive 101. The electric drive 101 includes a rectifier 104, a boost converter 106, a direct current (DC) bus 108 and an inverter 110. The system also includes a controller 112. The controller 112 may be any device configured to perform computational operations. For example, the controller 112 may be a processor, microprocessor or microcontroller, among others. The motor 102 may be a permanent magnet synchronous machine (PMSM).

The rectifier 104 has an input and an output. The rectifier 104 receives an alternating current (AC) signal over the input. The AC signal may be a single-phase AC signal, and the rectifier 104 may be a single phase rectifier. The rectifier 104 rectifies the AC signal and outputs DC voltage over the output.

The boost converter 106 may be any DC-to-DC power converter that steps up the DC voltage output by the rectifier 104 based on a power factor. The boost converter 106 may perform power factor correction (PFC) as controlled by the controller 112. The boost converter 106 has an input coupled to the output of the rectifier 104 and an output. The boost converter 106 steps up the DC voltage that is provided by the rectifier 104 and received by the boost converter 106. The boost converter 106 outputs a stepped-up voltage over the output. The boost converter 106 is shown in FIG. 1 to include an inductance 114, a switch 116, a diode 118 and a capacitance 120. The switch 116 may be an insulated-gate bipolar transistor (IGBT), among others.

The inductance 114 has a first terminal coupled to the output of the rectifier 104. The inductance 114 also has a second terminal. The switch 116 has a first conduction terminal coupled to the second terminal of the inductance 114. The switch 116 has a second conduction terminal and a control terminal. The diode 118 has an anode coupled to both the second terminal of the inductance 114 and the first conduction terminal of the switch 116. The capacitance 120 has a first side coupled to a cathode of the diode 118. The capacitance 120 has a second side coupled to the second conduction terminal of the switch 116. The second side of the capacitance 120 and the second conduction terminal of the switch 116 may be together coupled to ground and/or a second output of the rectifier 104.

The DC bus 108 may be configured to have a variable voltage. The DC bus 108 includes first and second lines, where the first line is coupled to the first side of the capacitance 120 and the second line is coupled to the second side of the capacitance 120. The inverter 110 has inputs coupled to the first and second lines, respectively. The inverter 110 inverts the DC voltage of the DC bus 108 (for example, the first line of the DC bus 108). The inverter 110 inverts the DC voltage into a three-phase AC voltage, where the three phases are represented as Va, Vb and Vc in FIG. 1. The motor 102 receives the three-phase AC voltage for operation of the motor 102.

The motor 102 may be a sensor-less motor. The motor 102 may be used for a compressor or fan in a refrigeration device, air conditioner or a home appliance, among others. In the compressor, for example, the voltage of the DC bus 108 may be elevated to operate motor 102 at a high speed. However, when the load on the compressor is low and the motor 102 is not operated at the high speed, elevating the voltage of the DC bus 108 results in increased heat dissipation and increased temperature. Consequently, elevated temperature may be detected in the switch 116, the diode 118, the inductance 114, the capacitance 120 and the controller 112. The techniques described herein operate the system 100 to reduce the temperature of the system 100.

The controller 112 has a plurality of inputs including a first input coupled to the input of the rectifier 104 and configured to receive the AC signal, a second input coupled to the DC bus 108 and configured to receive a voltage representative of the voltage of the DC bus 108 and a third input coupled to the inverter 110 and configured to receive first and second component voltages of the DC voltage that is inverted by the inverter 110. The first and second component voltages may be terminal voltages that are normalized in a d- and q-axis reference frame. The controller 112 has an output coupled to the switch 116. The controller 112 controls the switch 116 and consequently the boost converter 106 and the electric drive 101 to perform power factor correction and set the voltage of the DC bus 108 as described herein.

The controller 112 controls the switch 116 based on the AC signal and load conditions (e.g., motor 102 speed changes) to reduce losses and to automatically adjust the voltage of the DC bus 108 and the boost converter 106. The controller 112 limits the increase in temperature of components of the system 100. In doing so, the controller 112 reduces component failures and increases the lifespan of the components of the electric drive 101, motor 102 and controller 112.

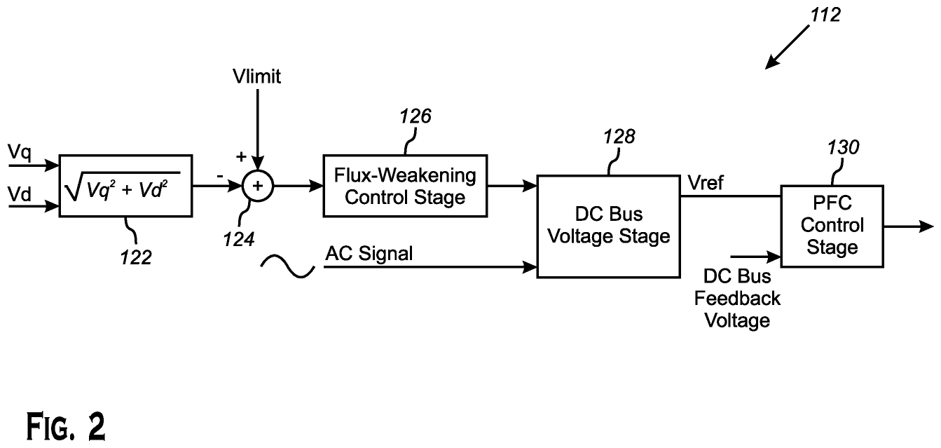

FIG. 2 shows a functional diagram of the controller 112. The controller includes an amplitude stage 122, a subtractor 124, a flux-weakening control stage 126, a DC bus voltage stage 128 and a power factor correction (PFC) control stage 130. The flux-weakening control stage 126 may be a proportional-integral (PI) controller or a PI control functionality of the controller 112. The flux-weakening control stage 126 may perform proportional-integral control as described herein.

The amplitude stage 122 has inputs configured to receive terminal voltages of the motor 102. The terminal voltages (denoted Vd and Vq) may be normalized in a d- and q-axis reference frame. The amplitude stage 122 may receive the terminal voltages (Vd, Vq) from the inverter 110. The inverter 110 may employ space-vector pulse width modulation (SVPWM) to convert the terminal voltages (Vd, Vq) into a three-phase voltage (Va, Vb, Vc) for operating the motor.

The amplitude stage 122 determines the amplitude of the terminal voltages (Vd, Vq) in the d-q system and outputs the amplitude to the subtractor 124. The amplitude may represent the total voltage resulting from the terminal voltages (Vd, Vq). The subtractor 124 also receives a limit voltage (Vlimit) for the amplitude. The limit voltage (Vlimit) may be set based on the characteristics of the power electronics of the system 100 including the motor 102. The limit voltage (Vlimit) may represent a cap on the amplitude (or a maximum voltage amplitude) to be used during operation of the system 100.

The subtractor 124 determines a difference between the limit voltage (Vlimit) and the amplitude and outputs the difference to the flux-weakening control stage 126. The flux-weakening control stage 126 causes a d-axis flux of the motor to be reduced. The flux-weakening control stage 126 lessens an effect of air-gap flux linkage of permanent magnets of the motor 102. For example, the flux-weakening control stage 126 may cause a negative d-axis component to be fed. The flux-weakening control stage 126 generates a d-axis reference current (Idref) based on the difference between the limit voltage (Vlimit) and the amplitude. The flux-weakening control stage 126 outputs the d-axis reference current (Idref) to the DC bus voltage stage 128. It is noted that flux-weakening uses stator current components to counter a fixed amplitude magnetic air gap flux generated by rotor magnets.

The DC bus voltage stage 128 receives the d-axis reference current (Idref) and the AC signal supplied to the rectifier 104. The DC bus voltage stage 128 determines a reference voltage (Vref) for the DC bus 108. The DC bus voltage stage 128 outputs the reference voltage (Vref) to the PFC control stage 130. The PFC control stage 130 receives the reference voltage (Vref) for the DC bus 108 and receives a DC bus feedback voltage. The reference voltage (Vref) may be a sought or desired voltage of the DC bus 108, and the DC bus feedback voltage may be a measurement of a voltage of the DC bus 108. The PFC control stage 130 controls the boost converter 106 to cause the voltage of the DC bus 108 to become equal to the reference voltage (Vref). The PFC control stage 130 may output a control signal to the boost converter 106 to operate the switch 116. The control signal may be a pulse width modulation (PWM) signal. The switch 116 is operated by transitioning the switch 116 between the conductive and non-conductive states. The control signal controls the switch to adjust the voltage of the DC bus 108 to approach or become equal to the reference voltage (Vref).

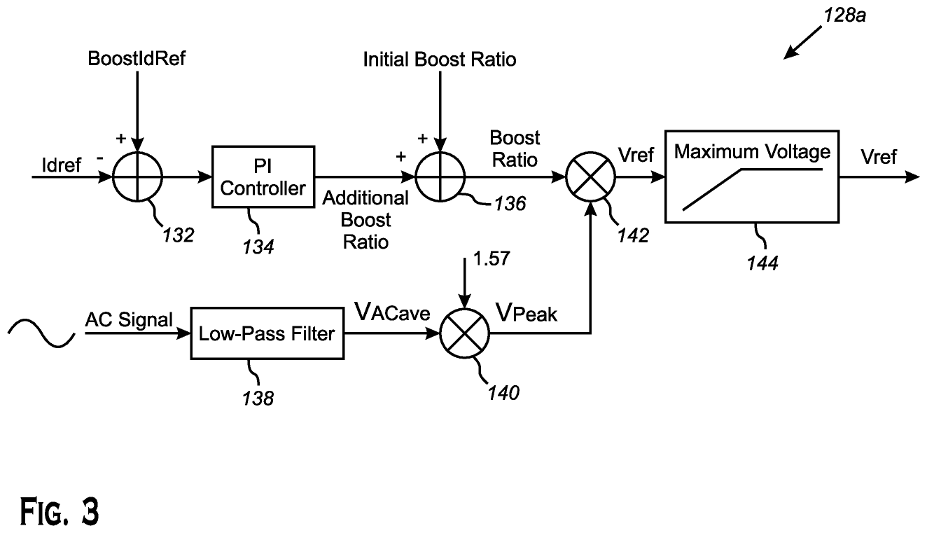

FIG. 3 shows a functional diagram of the DC bus voltage stage 128a of the controller 112 in accordance with an embodiment. The DC bus voltage stage 128a includes a subtractor 132, a PI controller 134, an adder 136, a low-pass filter 138, first and second multipliers 140, 142 and a maximum value stage 144.

The subtractor 132 has a first input for receiving the d-axis reference current (Idref) from the flux-weakening control stage 126, a second input for receiving a reference value (BoostIdRef) for the d-axis reference current and an output. The reference value (BoostIdRef) may be a desired or sought value for the d-axis reference current (Idref). The subtractor 132 determines a difference between the reference value (BoostIdRef) and the d-axis reference current (Idref) and outputs the difference to the PI controller 134. The difference may be an error between the reference value (BoostIdRef) and the d-axis reference current (Idref).

The PI controller 134 has an input for receiving the difference from the subtractor 132 and an output. The PI controller 134 may perform proportional-integral control and may be configured with a proportional gain (P) and an integral gain (K). The PI controller 134 may generate a first product of the difference (which may represent an error value) and the proportional gain (P). The PI controller 134 may also generate a second product of the integral gain (K) and an integral of the difference over a period of time. The PI controller 134 may then add the first and second products to generate an additional boost ratio for the AC signal. The additional boost ratio may be represented as:

$$Additional Boost Ratio = Pe ( t ) + K \int e ( t ) \qquad Equation ( 1 )$$

where e(t) is the difference between the reference value (BoostIdRef) and the d-axis reference current (Idref).

The PI controller 134 outputs the additional boost ratio over the output. The PI controller 134 operates to minimize, over time, the difference between the reference value (BoostIdRef) and the d-axis reference current (Idref). The PI controller 134 operates to bridge the difference between the reference value (BoostIdRef) and the d-axis reference current (Idref) to zero.

The adder 136 has a first input for receiving the additional boost ratio, a second input for receiving an initial boost ratio and an output. The initial boost ratio may be a minimum boost ratio by which the input DC voltage to the boost converter is to be boosted. The initial boost ratio may be greater than one to ensure that that the boost converter operates to step up the input DC voltage even when the additional boost ratio is small or zero. The adder 136 adds the additional boost ratio and the initial boost ratio to generate a boost ratio. The adder 136 outputs the boost ratio over the output.

The low-pass filter 138 has an input for receiving the AC signal and an output. The low-pass filter 138 receives the AC signal, filters the AC signal and generates an average voltage (V_{ACave}) for the AC signal. The average voltage (V_{ACave}) may be determined over any number of cycles of the AC signal. The low-pass filter 138 outputs the average voltage (V_{ACave}) for the AC signal over the output. The average voltage (V_{ACave}) may be determined for a half-wave of the AC signal. The average voltage (V_{ACave}) may be 0.637 of the peak voltage (V_{Peak}) of the AC signal. On the other hand, the root mean square (RMS) voltage may be 0.707 of the peak voltage (V_{Peak}) of the AC signal.

The first multiplier 140 has a first input for receiving the average voltage (V_{ACave}) and a second input for receiving a multiplier (or multiplicative scaling factor) for determining the peak voltage (V_{Peak}) from the average voltage (V_{ACave}). The average voltage (V_{ACave}) may be scaled by 1.57 (or 1/0.637) to produce the peak voltage (V_{Peak}). The first multiplier 140 receives 1.57 over the second input and multiplies the average voltage (V_{ACave}) and 1.57 to produce the peak voltage (V_{Peak}). The first multiplier 140 outputs the peak voltage (V_{Peak}) over its output.

The second multiplier 142 has a first input for receiving the boost ratio from the PI controller 134 and a second input for receiving the peak voltage (V_{Peak}) from the first multiplier 140. The second multiplier 142 multiplies the peak voltage (V_{Peak}) and the boost ratio to determine a reference voltage (Vref). The reference voltage (Vref) is a sought or desired voltage for the DC bus. The reference voltage (Vref) is a sought to be produced by the boost converter 106 and output over the DC bus 108. The boost converter 106 may raise or boost its input DC voltage to the reference voltage (Vref). The second multiplier 142 outputs the reference voltage (Vref) to the maximum value stage 144 for controlling the boost converter 106.

The maximum value stage 144 may limit the reference voltage (Vref) to a limit voltage. If the reference voltage (Vref) is less than or equal to the limit voltage, the maximum value stage 144 does not alter the reference voltage (Vref) and the maximum value stage 144 outputs the reference voltage (Vref) unaltered. If the reference voltage (Vref) is greater than the limit voltage, the maximum value stage 144 outputs the limit voltage as the reference voltage (Vref). The limit voltage may be set in accordance with the properties of the motor 102. Capping the reference voltage (Vref) at the limit voltage ensures that the reference voltage (Vref) determined by the DC bus voltage stage 128a is within the specifications of the motor 102. The maximum value stage 144 then outputs the reference voltage (Vref).

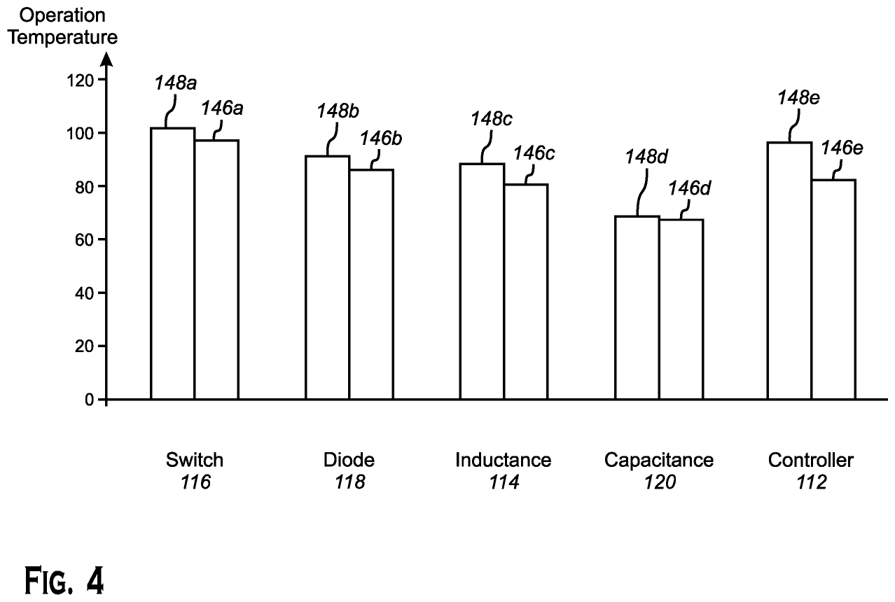

FIG. 4 shows temperature performance of the system 100. The operation temperatures 146a, 146b, 146c, 146d, 146e of the switch 116, diode 118, inductance 114, capacitance 120 and controller 112, respectively, when the motor 102 is operated per the techniques described herein are compared to the operation temperatures 148a, 148b, 148c, 148d, 148e when the motor 102 is operated in accordance with traditional power factor correction. As shown in FIG. 4, the switch 116, diode 118, inductance 114, capacitance 120 and controller 112 experience operate under lower temperatures per the techniques described herein. The reduced temperatures result in mitigating failures and extending the lifetimes of the components.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a motor;
an electric drive configured to:
receive an alternating current (AC) signal and convert the AC signal into a first direct current (DC) voltage;
receive a control signal; and
boost the first DC voltage, based on the control signal, to generate a second DC voltage for driving the motor; and
a controller configured to:
determine a reference current for performing flux-weakening control on the motor;
determine a reference voltage for the second DC voltage based on the reference current; and
generate the control signal based on the reference voltage.

2. The system according to claim 1, wherein the electric drive includes:
a DC bus; and
a boost converter configured to:
receive the first DC voltage;
boost the first DC voltage and generate the second DC voltage; and
output the second DC voltage to the DC bus.

3. The system according to claim 2, wherein the controller is configured to:
receive a feedback voltage representative of a voltage measurement of the DC bus; and
generate the control signal based on the feedback voltage and the reference voltage.

4. The system according to claim 3, wherein the controller is configured to generate the control signal to cause the feedback voltage to reach the reference voltage.

5. The system according to claim 1, wherein the controller is configured to:
determine a peak voltage of the AC signal;
determine a boost ratio for the peak voltage; and
generate the reference voltage as a product of the peak voltage and the boost ratio.

6. The system according to claim 5, wherein the controller is configured to determine the peak voltage by:
low-pass filtering the AC signal to determine an average voltage of the AC signal; and
multiply the average voltage by a scaling factor to generate the peak voltage.

7. The system according to claim 5, wherein the controller is configured to determine the boost ratio as a sum of a minimum boost ratio and an additional boost ratio.

8. The system according to claim 7, wherein the controller is configured to determine the additional boost ratio based on a difference between a d-axis component reference current of the electric drive and a desired value for the d-axis component reference current, wherein the d-axis component reference current is representation of current in a d-q coordinate system.

9. The system according to claim 8, wherein the electric drive converts a d-axis component and a q-axis component in the d-q coordinate system to a three-phase voltage for driving the motor.

10. A controller for a motor, comprising:
a plurality of inputs coupled to an electric drive of the motor; and
an output coupled to the electric drive of the motor,
wherein the controller is configured to:
receive, over a first input of the plurality of inputs, first and second component voltages of a first direct current (DC) voltage of the electric drive;
determine an additional boost ratio of the electric drive based on the first and second component voltages;
determine a boost ratio of the electric drive as a sum of a minimum boost ratio and the additional boost ratio, the boost ratio being a ratio by which the electric drive steps up a second DC voltage into the first DC voltage;
generate a control signal for controlling the electric drive based on the boost ratio; and
output, over the output, the control signal.

11. The controller according to claim 10, wherein the controller is configured to:
receive a feedback voltage representative of a voltage measurement of a DC bus of the electric drive; and
generate the control signal based on the feedback voltage and a reference voltage.

12. The controller according to claim 11, wherein the controller is configured to:
determine the reference voltage as a product of the boost ratio and a peak voltage of an alternating current (AC) signal provided to the electric drive.

13. The controller according to claim 12, wherein the controller is configured to:
low-pass filter the AC signal to determine an average voltage of the AC signal; and
multiply the average voltage by a scaling factor to determine the peak voltage.

14. The controller according to claim 10, wherein the controller is configured to:
determine the additional boost ratio based on a difference between a d-axis component reference current of the electric drive and a desired value for the d-axis component reference current, wherein the d-axis component reference current is representation of current in a d-q coordinate system.

15. The controller according to claim 14, wherein the controller is configured to:
determine the d-axis component reference current based on a magnitude of the first and second component voltages and a limit value of the magnitude.

16. A method, comprising:
receiving, over a first input of a plurality of inputs, first and second component voltages of a first direct current (DC) voltage of an electric drive;
determining an additional boost ratio of the electric drive based on the first and second component voltages;
determining a boost ratio of the electric drive as a sum of a minimum boost ratio and the additional boost ratio, the boost ratio being a ratio by which the electric drive steps up a second DC voltage into the first DC voltage;
generating a control signal for controlling the electric drive based on the boost ratio; and
outputting the control signal over an output.

17. The method according to claim 16, comprising:
receiving a feedback voltage representative of a voltage measurement of a DC bus of the electric drive; and
generating the control signal based on the feedback voltage and a reference voltage.

18. The method according to claim 17, comprising:
determining the reference voltage as a product of the boost ratio and a peak voltage of an alternating current (AC) signal provided to the electric drive.

19. The method according to claim 18, comprising:
low-pass filtering the AC signal to determine an average voltage of the AC signal; and
multiplying the average voltage by a scaling factor to determine the peak voltage.

20. The method according to claim 16, comprising:
determining the additional boost ratio based on a difference between a d-axis component reference current of the electric drive and a desired value for the d-axis component reference current, wherein the d-axis component reference current is representation of current in a d-q coordinate system; and
determining the d-axis component reference current based on a magnitude of the first and second component voltages and a limit value of the magnitude.
